(19) United States
(12) Patent Application Publication
(10) Pub. No.: US 2012/0236896 A1
(43) Pub. Date: Sep. 20, 2012

(54) ATMOSPHERE STABILIZATION METHOD AND LASER PROCESSING APPARATUS

(75) Inventors: Naoki Takida, Kanagawa (JP); Akio Date, Kanagawa (JP)

(73) Assignee: The Japan Steel Works ,Ltd., Tokyo (JP)

(21) Appl. No.: 13/500,238

(22) PCT Filed: Mar. 16, 2011
(86) PCT No.: PCT/JP2011/056185

§ 371 Date: Apr. 4, 2012

(51) Int. Cl. H01S 3/22

(52) U.S. Cl. 372/55

(57) ABSTRACT

Disruption of a gas atmosphere does not occur when a substrate is rotated 90° after it is carried into a laser processing apparatus. The substrate is carried such that a gas ejection port is positioned near a midportion of a first side of the substrate. The substrate is linearly moved to bring a center of the substrate near the gas ejection port and the substrate is horizontally rotated 90° about the center thereof. Because an edge portion of the gas ejection port does not go beyond a seal cover during rotation, disruption of the gas atmosphere that occurs due to the escaping of the gas does not occur.

### TECHNICAL FIELD

The present invention relates to an atmosphere stabilization method and a laser processing apparatus. More particularly, the present invention relates to an atmosphere stabilization method and a laser processing apparatus in which disruption of a gas atmosphere does not occur when a substrate is rotated after it is carried into the laser processing apparatus.

### BACKGROUND ART

A gas ejection unit provided in a laser processing apparatus for ejecting gas (for example, nitrogen gas) from a slit-shaped gas ejection port towards a substrate is known by the art (for example, see Patent Document 1). This gas ejection unit creates a gas atmosphere in a region that is to be irradiated with a laser beam when a laser processing is to be performed on the entire surface of an amorphous semiconductor substrate by moving the substrate while irradiating the substrate with a line-shaped laser beam

### [Conventional Art Documents]

### [Patent Documents]

[Patent Document 1] Japanese Patent Application Laid-open No. 2008-294101

### DISCLOSURE OF INVENTION

### Problem to be Solved by the Invention

FIGS. 11 to 15 are drawings for explaining a process of scanning a rectangular substrate P along a long side thereof with a laser beam 5. In FIG. 11, a short side of the substrate P located near the laser beam 5 and a gas ejection port 6 is denoted as a first side p1. In a clock-wise direction, the next long side is denoted as a second side p2, the next short side is denoted as a third side p3, and the next long side is denoted as a fourth side p4.

As conceptually shown in FIG. 11, the substrate P is carried into the laser processing apparatus such that the laser beam 5 and the gas ejection port 6 are positioned near a midportion of the first side p1. Meanwhile, in the structure shown in FIG. 11, the substrate P is carried in such that the laser beam 5 and the gas ejection port 6 are positioned at an edge portion of a seal cover 8 that is protruding out from the midportion of the first side p1. However, the substrate P may be sometimes carried in such that the laser beam 5 and the gas ejection port 6 are positioned above or on an immediate inner side of the midportion of the first side p1.

In the structure shown in FIG. 11, the gas ejected from the gas ejection port 6 strikes the edge portion of the seal cover 8 and a gas atmosphere is created in a region that is to be irradiated with the laser beam 5.

Before starting scanning of the substrate P with the laser beam 5, the substrate P is moved in a direction of an arrow y11 shown in FIG. 11 and the laser beam 5 and the gas ejection port 6 are positioned at the edge portion of the seal cover 8 that corresponds to the outside of a left half portion of the first side p1 as shown in FIG. 12.

Subsequently, the substrate P is moved in a direction of an arrow x11 shown in FIG. 12 and the left half portion of the substrate P is subjected to laser processing as shown in FIG. 13. Immediately after completion of the laser processing of the left half portion of the substrate P, the laser beam 5 and the gas ejection port 6 are positioned at the edge portion of the seal cover 8 that is protruding out from a left half portion of the third side p3.

Thereafter, the substrate P is moved in a direction of an arrow y12 shown in FIG. 13 and the laser beam 5 and the gas ejection port 6 are positioned at the edge portion of the seal cover 8 that is protruding out from a right half portion of the third side p3 as shown in FIG. 14.

Then, the substrate P is moved in a direction of an arrow x12 shown in FIG. 14 and the right half portion of the substrate P is subjected to laser processing as shown in FIG. 15. Immediately after the laser processing of the right half portion of the substrate P, the laser beam 5 and the gas ejection port 6 are positioned at the edge portion of the seal cover 8 that is protruding out from a right half portion of the first side p1.

Subsequently, the substrate P is moved in a direction of an arrow y13 shown in FIG. 15, and returned to the position shown in FIG. 11. Thereafter, the substrate P is carried out of the laser processing apparatus.

When scanning the substrate P along the short side thereof with the laser beam 5, the substrate P is rotated by 90° about the center thereof after the substrate P is carried into the laser processing apparatus as shown in FIG. 11. As shown in FIG. 16, the laser beam 5 and the gas ejection port 6 are positioned at the edge portion of the seal cover 8 that is protruding out from the midportion of the second side p2. The substrate P is scanned along the short side thereof with the laser beam 5 by moving the substrate P similarly as when the substrate P is scanned along the long side thereof with the laser beam 5.

FIG. 17 is a drawing of a state where the substrate P is being rotated to a position shown in FIG. 16 after the substrate P is carried into the laser processing apparatus as shown in FIG. 11.

When the substrate P is rotated in a direction of an arrow α, an end portion N of the gas ejection port 6 goes beyond the seal cover 8, and therefore, the gas escapes from the seal cover 8.

This creates disruption of the gas atmosphere and some time is required for stabilization of the gas atmosphere after the substrate P is rotated to a position shown in FIG. 16. As a result, the scanning cannot be started immediately.

It is an object of the present invention to provide an atmosphere stabilization method and a laser processing apparatus in which disruption of the gas atmosphere does not occur during the rotation of the substrate after the substrate is carried into the laser processing apparatus.

### Means for Solving Problem

According to a first aspect there is provided an atmosphere stabilization method implemented on a laser processing apparatus (100) that includes substrate supporting units (2, 11, 12, 13, and 14) that include a substrate supporting surface that supports a rectangular substrate (P) having a first side (p1), a second side (p2), a third side (p3), and a fourth side (p4), and that enable linear movement of the substrate supporting surface in a two dimensional coordinate system that is parallel to the substrate supporting surface, and enable rotation of the substrate supporting surface about a central axis that is orthogonal to the substrate supporting surface; a rectangular seal cover (8) that is provided between the substrate (P) and the substrate supporting surface such that edge portions of the seal cover (8) protrude out the substrate (P) when the substrate (P) is supported by the substrate supporting surface; a laser light source (4) that irradiates the substrate (P) with a line-shaped laser beam (5); and a slit-shaped gas ejection port (6) that ejects gas towards the substrate (P) when creating a gas atmosphere in a region to be irradiated with the laser beam (5). The atmosphere stabilization method includes supporting the substrate (P) so that the gas ejection port (6) is positioned near a midportion of the first side (p1), linearly moving the substrate (P) so as to bring the center of the substrate (P) near the gas ejection port (6), and thereafter rotating the substrate (P).

In the atmosphere stabilization method according to the first aspect described above, when the substrate (P) is rotated, an edge portion of the gas ejection port (6) does not go beyond the seal cover (8). Therefore, disruption of a gas atmosphere does not occur and a stable gas atmosphere is maintained. As a result, the scanning of the substrate (P) can be immediately started even after rotation of the substrate (P).

At an initial position, because the substrate (P) is supported such that the gas ejection port (6) is positioned near the midportion of the first side (p1), the scanning of the substrate (P) can be immediately started without rotating the substrate (P). That is, a case where scanning is started after the rotation of the substrate (P) from the initial position thereof and a case where scanning is started without rotating the substrate (P) from the initial position thereof can be handled.

As the initial position, if the substrate (P) is supported such that the gas ejection port (6) is positioned near a center of the substrate (P), the end portion of the gas ejection port (6) will not go beyond the seal cover (8) even if the substrate (P) is rotated without performing the linear movement. However, when the scanning is to be started, it is necessary to linearly move the substrate (P) such that the gas ejection port (6) is positioned near any one of the sides of the substrate (P). Therefore, supporting the substrate (P) in such a manner is not desirable.

If a sufficiently large seal cover (8) is used, the end portion of the gas ejection port (6) will not go beyond the seal cover (8) even if the substrate (P) is rotated without performing the linear movement from the initial position. However, if the size of the seal cover (8) is increased, the size of the laser processing apparatus also increases. Therefore, increasing the size of the seal cover (8) is not desirable.

According to a second aspect there is provided an atmosphere stabilization method in which, in the atmosphere stabilization method according to the first aspect, the linear moving and the rotating is performed concurrently.

If timings are properly adjusted, the edge portion of the gas ejection port (6) will not go beyond the seal cover (8) even if the linear movement and the rotation are concurrently performed. Therefore, the overall processing time can be reduced compared to a time required for performing the linear movement and the rotation sequentially.

According to a third aspect there is provided a laser processing apparatus (100) including substrate supporting units (2, 11, 12, 13, and 14) that include a substrate supporting surface that supports a rectangular substrate (P) having a first side (p1), a second side (p2), a third side (p3), and a fourth side (p4), and that enable linear movement of the substrate supporting surface in a two dimensional coordinate system that is parallel to the substrate supporting surface, and enable rotation of the substrate supporting surface about a central axis that is orthogonal to the substrate supporting surface; a rectangular seal cover (8) that is provided between the substrate (P) and the substrate supporting surface such that edge portions of the seal cover (8) protrude out the substrate (P) when the substrate (P) is supported by the substrate supporting surface; a laser light source (4) that irradiates the substrate (P) with a line-shaped laser beam (5); a slit-shaped gas ejection port (6) that ejects gas towards the substrate (P) when creating a gas atmosphere in a region to be irradiated with the laser beam (5); and a control means (20) that supports the substrate (P) so that the gas ejection port (6) is positioned near a midportion of the first side (p1), linearly moves the substrate (P) so as to bring the center of the substrate (P) near the gas ejection port (6), and thereafter rotates the substrate (P).

In the laser processing apparatus (100) according to the third aspect described above, when the substrate (P) is rotated, the end portion of the gas ejection port (6) does not go beyond the seal cover (8). Therefore, disruption of the gas atmosphere does not occur and a stable gas atmosphere is maintained. As a result, the scanning of the substrate (P) can be immediately started even after rotation of the substrate (P).

At an initial position, because the substrate (P) is supported such that the gas ejection port (6) is positioned near the midportion of the first side (p1), the scanning of the substrate (P) can be immediately started without rotating the substrate (P). That is, a case where scanning is started after the rotation of the substrate (P) from the initial position thereof and a case where scanning is started without rotating the substrate (P) from the initial position thereof can be handled.

As the initial position, if the substrate (P) is supported such that the gas ejection port (6) is positioned near the center of the substrate (P) the end portion of the gas ejection port (6) will not go beyond the seal cover (8) even if the substrate (P) is rotated without performing the linear movement. However, when the scanning is to be started, it is necessary to linearly move the substrate (P) such that the gas ejection port (6) is positioned near any one of the sides of the substrate (P). Therefore, supporting the substrate (P) in such a manner is not desirable.

If a sufficiently large seal cover (8) is used, the end portion of the gas ejection port (6) will not go beyond the seal cover (8) even if the substrate (P) is rotated without performing the linear movement from the initial position.

However, the large seal cover (8) will lead to an increase in the size of the laser processing apparatus. Therefore, increasing the size of the seal cover (8) is not desirable.

According to a fourth aspect there is provided a laser processing apparatus in which, in the laser processing apparatus according to the third aspect, the control means (20) concurrently performs the linear movement and the rotation.

If timings are properly adjusted, the edge portion of the gas ejection port (6) does not go beyond the seal cover (8) even if the linear movement and the rotation are concurrently performed. Therefore, the overall processing time can be reduced compared to the time required for performing the linear movement and the rotation sequentially.

### Advantages of the Invention

According to an atmosphere stabilization method and a laser processing apparatus of the present invention, when a substrate is rotated after the substrate is carried into the laser processing apparatus, disruption of a gas atmosphere can be prevented from occurring due to the rotation. Consequently, scanning can be immediately started after rotation of the substrate and productivity can be improved.

### BRIEF DESCRIPTION OF DRAWINGS

FIG. 1 is a drawing of a structure of a laser annealing apparatus according to a first embodiment of the present invention.

FIG. 2 is a conceptual plan view showing an initial position of the substrate when it is carried in.

FIG. 3 is a conceptual plan view showing a linear movement process according to the first embodiment.

FIG. 4 is a conceptual plan view of a state during rotation of the substrate according to the first embodiment.

FIG. 5 is a conceptual plan view of a state after rotation of the substrate according to the first embodiment.

FIG. 6 is a conceptual plan view of a state when scanning of a left half portion of the substrate has started.

FIG. 7 is a conceptual plan view of a state when scanning of the left half portion of the substrate has ended.

FIG. 8 is a conceptual plan view of a state when scanning of a right half portion of the substrate has started.

FIG. 9 is a conceptual plan view of a state when scanning of the right half portion of the substrate has ended.

FIG. 10 is a conceptual plan view showing a positional relation when the substrate is carried out.

FIG. 11 is a conceptual plan view showing an initial position of the substrate when it is carried in.

FIG. 12 is a conceptual plan view of a state when scanning of the left half portion of the substrate has started.

FIG. 13 is a conceptual plan view of a state when scanning of the left half portion of the substrate has ended.

FIG. 14 is a conceptual plan view of a state when scanning of the right half portion of the substrate has started.

FIG. 15 is a conceptual plan view of a state when scanning of the right half portion of the substrate has ended.

FIG. 16 is a conceptual plan view of a state after conventional rotation of a substrate.

FIG. 17 is a conceptual plan view of a state during conventional rotation of the substrate.

### BEST MODE(S) FOR CARRYING OUT THE INVENTION

Exemplary embodiments of the present invention are explained in detail below with reference to the accompanying drawings. However, the present invention is not to be thus limited.

### First Embodiment

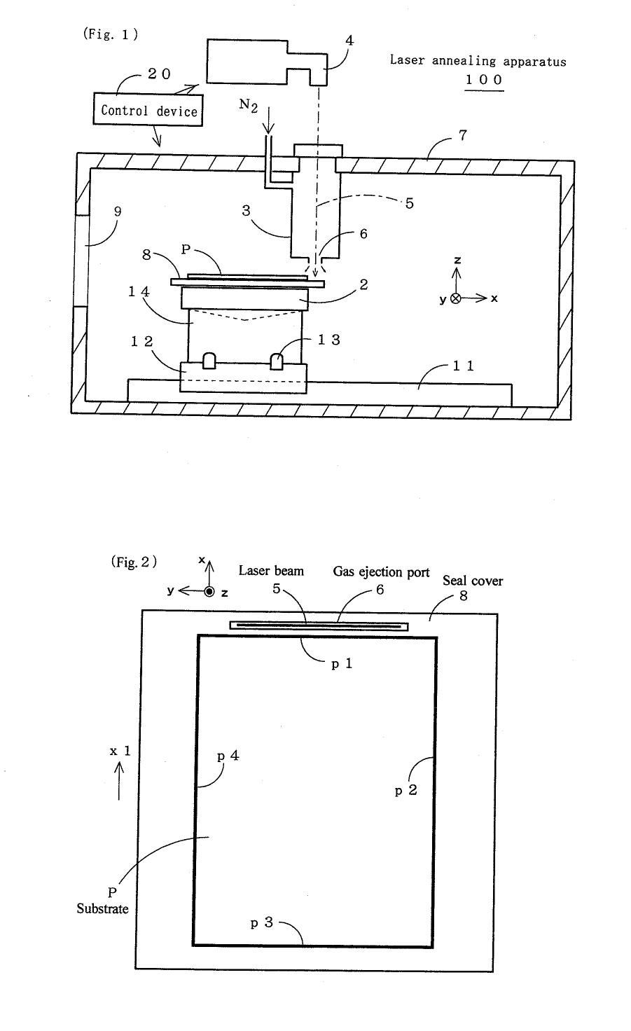

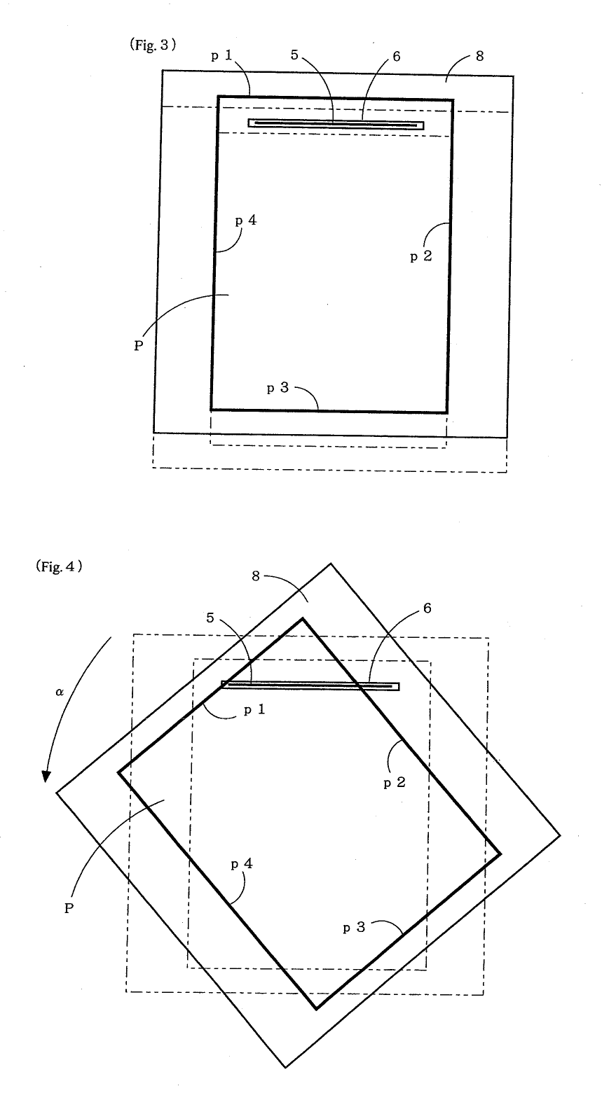

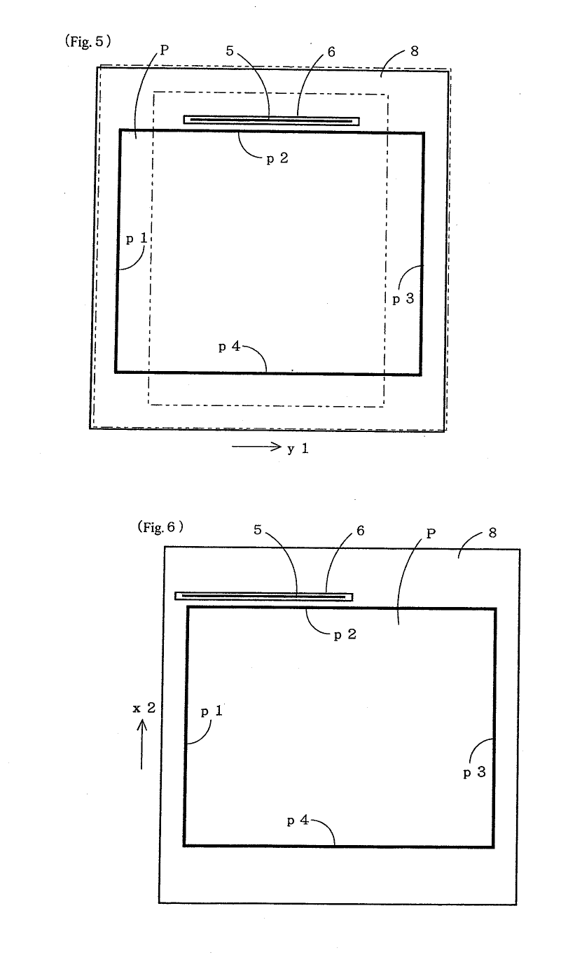

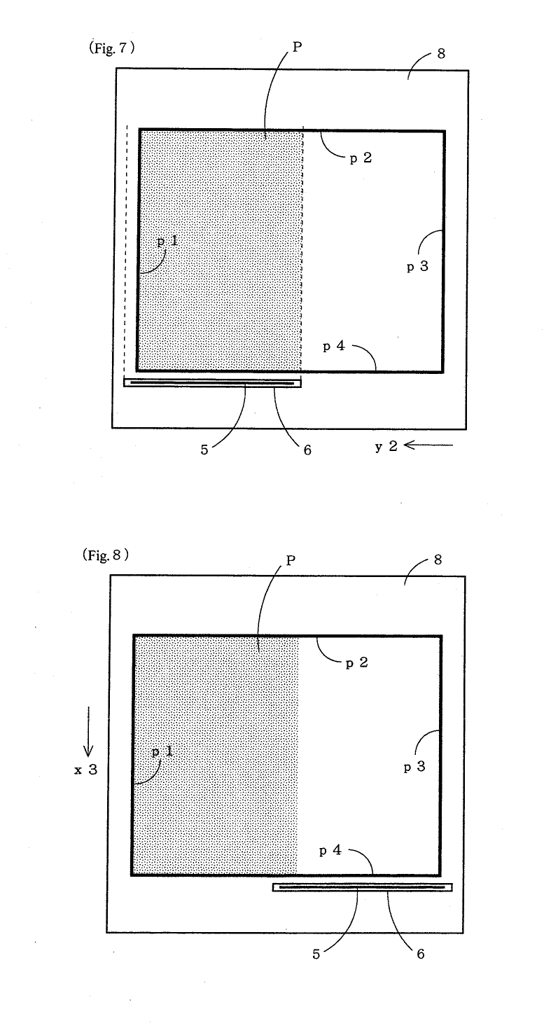

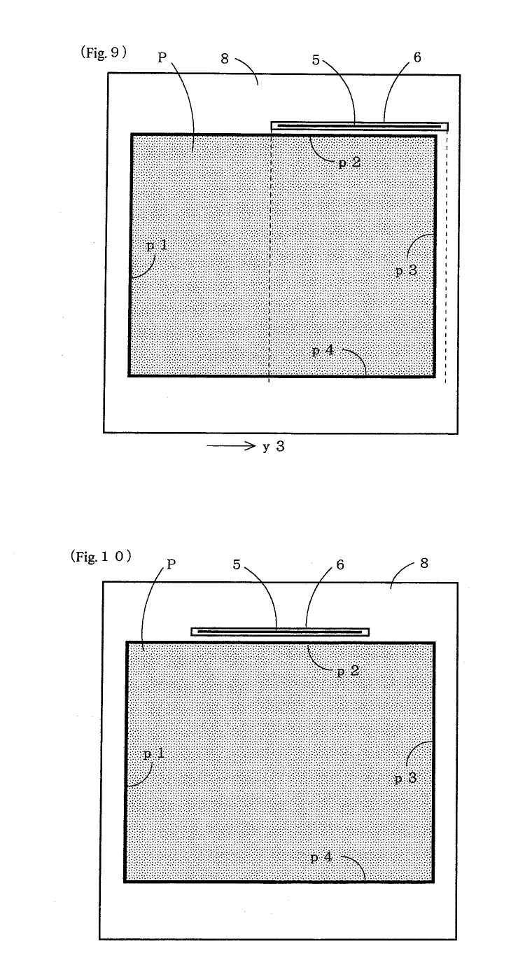

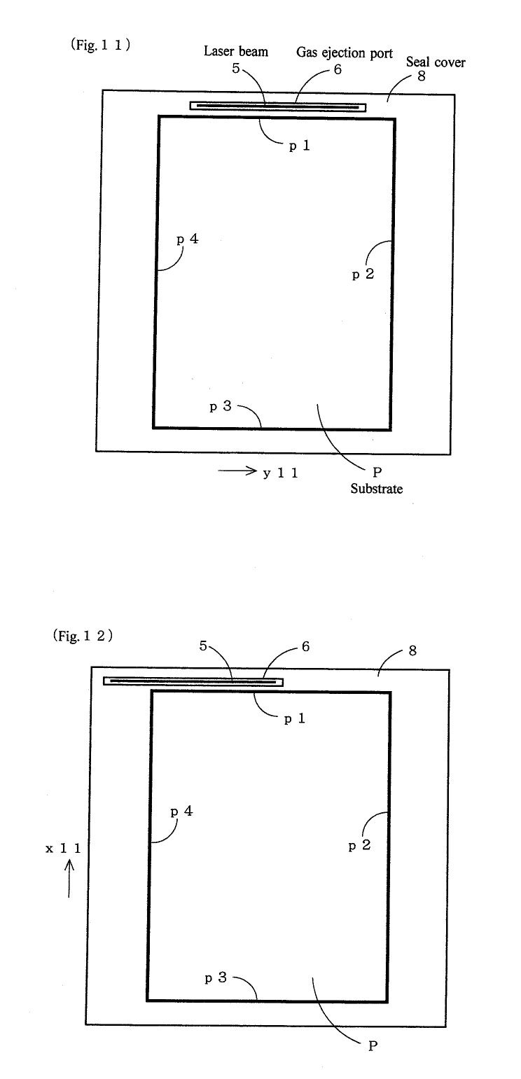

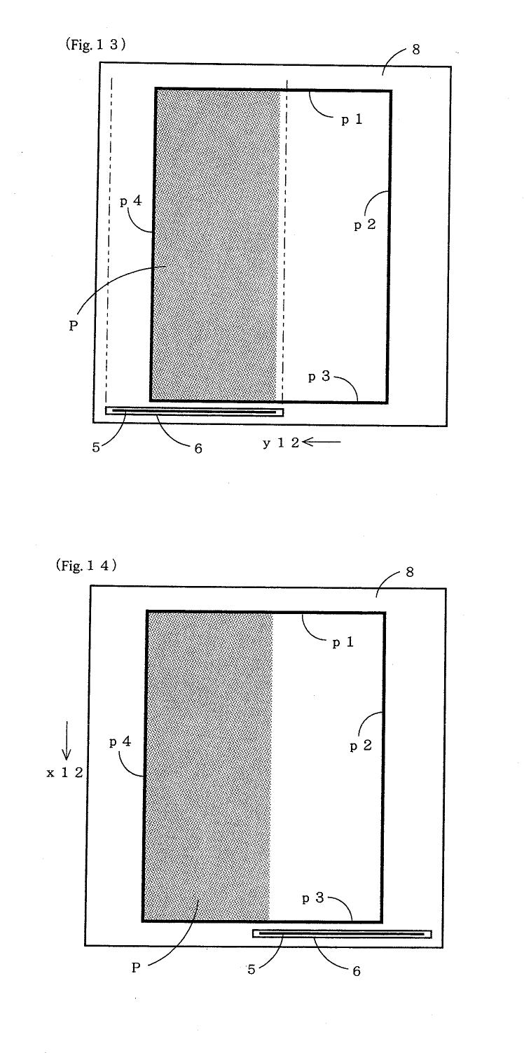

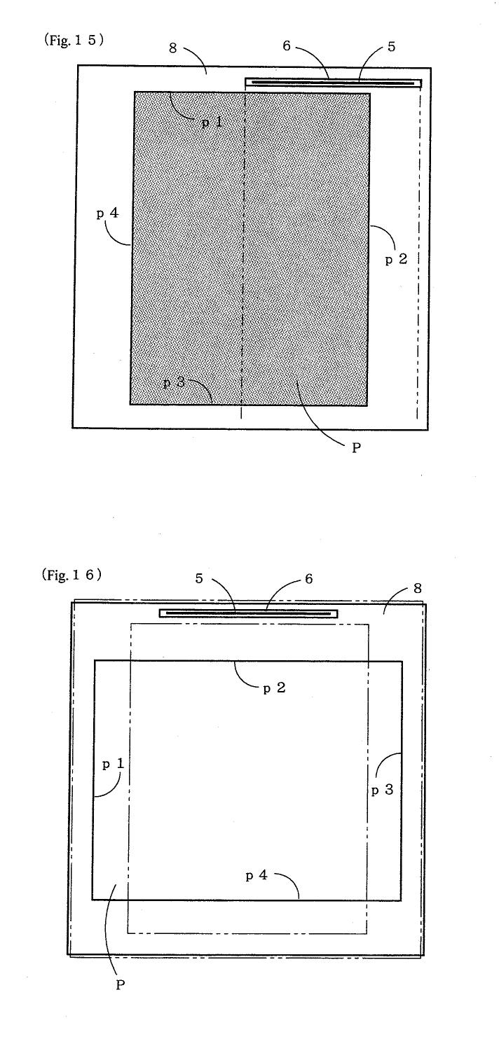

FIG. 1 is a drawing of a structure of a laser annealing apparatus 100 according to a first embodiment of the present invention.

The laser annealing apparatus 100 includes a chamber 7 that includes a laser-beam transmission window 1 and a substrate carry-in/out port 9, a rail 11 that is arranged on a floor surface of the chamber 7, an X-table 12 that is linearly movable above the rail 11 in an x direction, a rail 13 that is arranged at the front surface of the X-table 12, a Y-table 14 that is linearly movable above the rail 13 in a y direction, a horizontally rotatable rotating platform 2 that is supported by the Y-table 12, a seal cover 8 that is provided on the rotating platform 2, a laser light source 4 for irradiating a substrate P mounted on the seal cover 8 with a laser beam 5, a local seal box 3 that includes a gas ejection port 6 for ejecting gas (for example, nitrogen gas) towards the substrate P so as to create a gas atmosphere in a region that is to be irradiated with the laser beam 5, and a control device 20 that controls switching on/off of the laser light source 4, the linear movement of the X-table 12, etc.

FIG. 2 is a conceptual diagram for explaining a positional relation among the substrate P, the seal cover 8, the laser beam 5, and the gas ejection port 6.

The substrate P is rectangular and has a first side p1, a second side p2, a third side p3, and a fourth side p4.

The seal cover 8 is also rectangular and the substrate P is mounted thereon such that edge portions of the seal cover 8 protrude from the periphery the substrate P.

The laser beam 5 is line-shaped.

The gas ejection port 6 is slit-shaped.

As conceptually shown in FIG. 2, the substrate P is carried in from the substrate carry-in/out port 9 such that the laser beam 5 and the gas ejection port 6 are positioned near a midportion of the first side p1.

In FIG. 2, the substrate P is carried in such that the laser beam 5 and the gas ejection port 6 are positioned at the edge portion of the seal cover 8 that is protruding out from the midportion of the first side p1. However, depending on the situations, the substrate P may be carried in such that the laser beam 5 and the gas ejection port 6 are positioned above or on an immediate inner side of the midportion of the first side p1.

In the structure shown in FIG. 2, the gas ejected from the gas ejection port 6 strikes the edge portion of the seal cover 8 and the gas atmosphere is created in the region that is to be irradiated with the laser beam 5.

In actuality, designing has been done such that when the substrate P is carried in with the side p1 thereof parallel to a line of the laser beam 5 and a center thereof matching a rotation axis of the rotating platform 2, the laser beam 5 and the gas ejection port 6 are positioned near the midportion of the first side p1.

An operation of scanning the substrate P along a long side thereof with the laser beam 5 is the same as the operation explained with reference to FIGS. 11 to 15. Hence, the explanation thereof is omitted.

An operation of scanning the substrate P along a short side thereof with the laser beam 5 is explained with reference to FIGS. 2 to 10.

The substrate P is linearly moved in a direction of an arrow x1 shown in FIG. 2 so as to bring the center of the substrate P near the gas ejection port 6 as shown in FIG. 3. The two-dot chain line shown in FIG. 3 indicates a position of the substrate P when it is carried in. How a distance of the linear movement of the substrate P is determined is described later.

As shown in FIG. 4, the substrate P is rotated about the center thereof.

In the present embodiment, even if the substrate P is rotated in a direction of an arrow α, the gas ejection port 6 does not go beyond the seal cover 8. Consequently, a stable gas atmosphere can be maintained.

As shown in FIG. 5, after the substrate P is rotated by 90°, the substrate P is moved in a direction of an arrow y1 shown in FIG. 5, and the laser beam 5 and the gas ejection port 6 are positioned at the edge portion of the seal cover 8 that corresponds to the outer side of a left half portion of the second side p2.

Thereafter, the substrate P is moved in a direction of an arrow x2 shown in FIG. 6 and the left half portion of the substrate P is subjected to laser annealing. Immediately after completion of the laser annealing of the left half portion of the substrate P, the laser beam 5 and the gas ejection port 6 are positioned at the edge portion of the seal cover 8 that is protruding out from a left half portion of the fourth side p4.

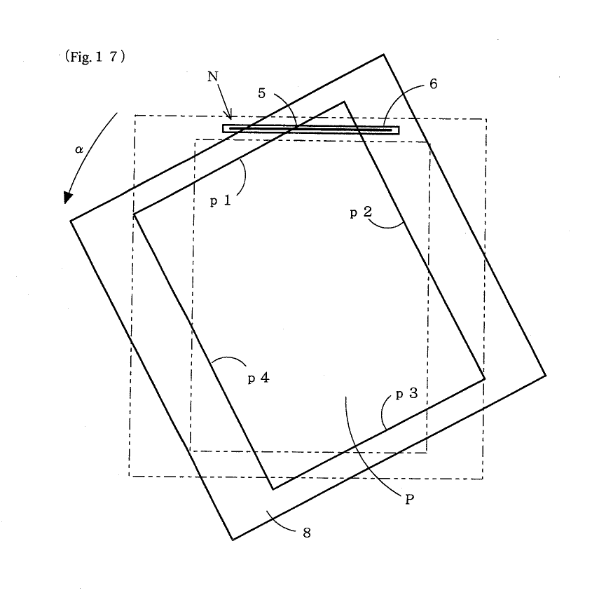

Thereafter, the substrate P is moved in a direction of an arrow y2 shown in FIG. 7, and the laser beam 5 and the gas ejection port 6 are positioned at the edge portion of the seal cover 8 that is protruding out from a right half portion of the fourth side p4 as shown in FIG. 8.

The substrate P is moved in a direction of an arrow x3 shown in FIG. 8 and the right half portion of the substrate P is subjected to laser annealing as shown in FIG. 9. Immediately after completion of the laser annealing of the right half portion of the substrate P, the laser beam 5 and the gas ejection port 6 are positioned at the edge portion of the seal cover 8 that is protruding out from the right half portion of the second side p2.

The substrate P is moved in a direction of an arrow y3 shown in FIG. 9 and returned to the position shown in FIG. 10. Thereafter, the substrate P is carried out from the laser annealing apparatus 100.

In the laser annealing apparatus 100 according to the first embodiment, when the substrate P is rotated by 90° after it is carried in, the edge portion of the gas ejection port 6 does not go beyond the seal cover 8 during the rotation. Therefore, disruption of the gas atmosphere does not occur during the rotation. Therefore, no waiting time is required for stabilization of the gas atmosphere after the substrate P is rotated by 90° and hence the productivity can be improved.

Method of determining the linear movement distance of the substrate P to bring the center of the substrate P near the gas ejection port 6

As can be inferred from FIG. 3, linear movement distance=L0-L90+A, assuming L0 to be a distance between the gas ejection port 6 and the center of the substrate P shown in FIG. 2, L90 to be a distance between the gas ejection port 6 and the center of the substrate P shown in FIG. 5, and A to be an adjustment value based on a length and a width of the gas ejection port 6. The distance L0 between the gas ejection port 6 and the center of the substrate P shown in FIG. 2 is “half of the length of the long side of the substrate P”+ “the distance between the first side p1 and the gas ejection port 6”. The distance L90 between the gas ejection port 6 and the center of the substrate P shown in FIG. 5 is “half of the length of the short side of the substrate P “+” the distance between the second side p2 and the gas ejection port 6”. Consequently, linear movement distance=(“long side length of substrate P“−” short side length of substrate P”)/2+(“distance between first side p1 and gas ejection port 6 in FIG. 2 “−” distance between second side p2 and gas ejection port 6 in FIG. 5”)+A.

### Second Embodiment

The control means 20 concurrently performs the linear movement x1 shown in FIG. 2 and the rotation a shown in FIG. 4.

If timings are properly adjusted, the edge portion of the gas ejection port 6 will not go beyond the seal cover 8 during the rotation of the substrate P even if the linear movement and the rotation are concurrently performed. Therefore, the overall time can be reduced compared to the time required for performing the linear movement and the rotation sequentially.

### INDUSTRIAL APPLICABILITY

The atmosphere stabilization method and the laser processing apparatus according to the present invention can be used, for example, in the laser annealing for an amorphous semiconductor substrate.

### EXPLANATIONS OF LETTERS OR NUMERALS

1: Laser-beam transmission window
2: Rotating platform
3: Local seal box
4: Laser light source
5: Laser beam
6: Gas ejection port

### 7: Chamber

8: Seal cover

### 11, 13: Rail

### 12: X-table

### 14: Y-table

20: Control device
100: Laser annealing apparatus
P: Substrate

1. An atmosphere stabilization method implemented on a laser processing apparatus comprising
substrate supporting units that include a substrate supporting surface that supports a rectangular substrate having a first side, a second side, a third side, and a fourth side, and that enable linear movement of the substrate supporting surface in a two dimensional coordinate system that is parallel to the substrate supporting surface, and enable rotation of the substrate supporting surface about a central axis that is orthogonal to the substrate supporting surface;
a rectangular seal cover that is provided between the substrate and the substrate supporting surface such that edge portions of the seal cover protrude out the substrate when the substrate is supported by the substrate supporting surface;
a laser light source that irradiates the substrate with a line-shaped laser beam; and
a slit-shaped gas ejection port that ejects gas towards the substrate when creating a gas atmosphere in a region to be irradiated with the laser beam,
the atmosphere stabilization method comprising supporting the substrate so that the gas ejection port is positioned near a midportion of the first side, linearly moving the substrate so as to bring the center of the substrate near the gas ejection port, and thereafter rotating the substrate.

2. The atmosphere stabilization method according to claim 1, wherein the linear moving and the rotating is performed concurrently.

3. A laser processing apparatus comprising:
substrate supporting units that include a substrate supporting surface that supports a rectangular substrate having a first side, a second side, a third side, and a fourth side, and that enable linear movement of the substrate supporting surface in a two dimensional coordinate system that is parallel to the substrate supporting surface, and enable rotation of the substrate supporting surface about a central axis that is orthogonal to the substrate supporting surface;
a rectangular seal cover that is provided between the substrate and the substrate supporting surface such that edge portions of the seal cover protrude out the substrate when the substrate is supported by the substrate supporting surface;
a laser light source that irradiates the substrate with a line-shaped laser beam;
a slit-shaped gas ejection port that ejects gas towards the substrate when creating a gas atmosphere in a region to be irradiated with the laser beam; and
a control means that supports the substrate so that the gas ejection port is positioned near a midportion of the first side, linearly moves the substrate so as to bring the center of the substrate near the gas ejection port, and thereafter rotates the substrate.

4. The laser processing apparatus according to claim 3, wherein the control means concurrently performs the linear movement and the rotation.
